(19) United States
(12) Patent Application Publication
(10) Pub. No.: US 2025/0037909 A1
(43) Pub. Date: Jan. 30, 2025

(54) ELECTRONIC COMPONENT

(71) Applicant: KOA CORPORATION, INA-SHI, NAGANO (JP)

(72) Inventors: Kyohei MIYASHITA, INA-SHI, NAGANO (JP); Mizuki UCHIMORI, INA-SHI, NAGANO (JP); Daigo HAYASHI, INA-SHI, NAGANO (JP)

(21) Appl. No.: 18/712,815

(22) PCT Filed: Oct. 31, 2022
(86) PCT No.: PCT/JP2022/040709

§ 371 Date: May 23, 2024

(30) Foreign Application Priority Data
Dec. 7, 2021 (JP) 2021-198587

(51) Int. Cl. H01C 1/028; H01C 1/14

(52) U.S. Cl. CPC H01C 1/028; H01C 1/14

(57) ABSTRACT

An electronic component that can secure a creepage distance between electrode terminals has a structure in which an upper portion having a rectangular shape in plan view and a predetermined thickness, a housing portion formed at the center on an undersurface side of the upper portion to house a resistance element, and first, second, and third protruding portions, each of which extends in a vertical direction from the undersurface side of the upper portion to serve as a leg portion, are formed. A concave portion having a predetermined depth is formed between the first and third protruding portions and between the second and third protruding portions on the undersurface side of the upper portion, such that the concave portion extends from one side in a widthwise direction on the undersurface side to the other side through the housing portion to secure a long creepage distance between electrode terminals.

### TECHNICAL FIELD

The present invention relates to an electronic component for high voltage.

### BACKGROUND ART

For example, a divider product to be used as a resistor for a voltage-dividing circuit in an on-board BMS and the like is normally formed of a plurality of high-precision thin film and thick film resistances. In contrast, in a molded divider, voltage-dividing resistances formed of a plurality of chip resistors are integrated into a single package, which can reduce the mounting area and make the voltage-dividing resistances more precise.

Since the molded divider is capable of dividing the voltage in a single package as described above, a high voltage of 500 V or higher, or even 1000 V or higher may be applied between electrodes depending on the specifications. It is thus necessary for the molded divider to take the insulation properties into consideration.

For example, Patent Document 1 discloses an electrical device designed for high voltage application that serves as a voltage divider. The electrical device has a configuration in which an electrical element is mounted inside an insulating molded body, and lead terminals are connected to the left and right sides of the molded body. Ribs are provided on at least a portion of the surface of the molded body between these lead terminals, thereby increasing the surface area and thus improving the voltage performance.

### PRIOR ART DOCUMENTS

### Patent Documents

Patent Document 1: Japanese Patent Application National Publication No. 2018-522423

### DISCLOSURE OF THE INVENTION

### Problem to be Solved by the Invention

The molded body with ribs such as the electrical device disclosed in Patent Document 1, that is, a molded device provided with a plurality of continuous shallow ribs on lateral sides and back side of a mold, results in a reduced distance between the ribs, although an apparent creepage distance between electrode terminals can be secured. In view of that, for example, depending on the pollution condition in the environment where the electrical device is installed, the distance along the surfaces of the ribs may not be directly regarded as a creepage distance, which may limit the environment where the electrical device can be used.

Further. when a plurality of continuous thin ribs are provided, the spacing between the ribs is reduced. In addition, these ribs make the structure more complicated, and may cause a molding defect such as a chipped mold or cause foreign objects or the like to be more likely to be trapped between the ribs. It is also difficult to check for these problems. This results in a problem that production efficiency of the products deteriorates.

The present invention has been made in light of the above problems, and aims to provide an electronic component such as a thick film molded divider that can avoid the structure from becoming complicated, and secure a creepage distance between electrode terminals.

### Means of Solving the Problem

In order to achieve the above object and as a means for resolving the above problems. for example, the following structure is included. That is, an electronic component according to the present invention is characterized in comprising: an upper portion made of a plate-like exterior material and having a rectangular shape in a planar view: a housing portion arranged substantially at a center part on an undersurface side of the upper portion and made of an exterior material for embedding a resistance element therein: a first protruding portion made of an exterior material, formed upright at one end side in a longitudinal direction of an undersurface side of the upper portion, having a predetermined height in a vertical direction from the undersurface side, and having a first electrode terminal provided thereon: a second protruding portion made of an exterior material, formed upright at the other end side in a longitudinal direction of an undersurface side of the upper portion, having a predetermined height in a vertical direction from the undersurface side, and having a second electrode terminal provided thereon; and a third protruding portion made of an exterior material, formed upright on an undersurface side of the upper portion and at a position where the third protruding portion is sandwiched between the first protruding portion and the second protruding portion, while being spaced apart with a predetermined distance from each of the first protruding portion and the second protruding portion, and having a predetermined height in a vertical direction from the undersurface side, wherein each of the first protruding portion, the second protruding portion, and the third protruding portion is formed to extend from one end part to the other end part in a widthwise direction of the undersurface side, while having a constant width in the longitudinal direction.

For example, it is characterized in that the third protruding portion has a width in the longitudinal direction greater than a separation distance between the first protruding portion and the third protruding portion, and a separation distance between the second protruding portion and the third protruding portion. For example, it is characterized in that the third protruding portion has a height in the vertical direction greater than a height of the first protruding portion in the vertical direction and a height of the second protruding portion in the vertical direction. It is also characterized in that, for example, between the first protruding portion and the third protruding portion, and between the second protruding portion and the third protruding portion, regions on both end face sides in the widthwise direction of the undersurface side and the regions adjacent to the housing portion have a depth in the vertical direction greater than a depth of the housing portion in the vertical direction. Further, for example, it is characterized in that the regions remain as they are without penetrating the upper portion in the vertical direction from a top surface side to an undersurface side. For example, it is characterized in that the upper portion has an area where the first electrode terminal and the second electrode terminal are hidden by the upper portion in a planar view. For example, it is characterized in that each of the first electrode terminal and the second electrode terminal is pulled out to the outside through the exterior material from a position three-quarters or more of the height of the first protruding portion and the second protruding portion in the vertical direction. It is further characterized in that, for example, at the position where the electrode terminal is pulled out the outside, each of the first electrode terminal and the second electrode terminal has predetermined regions narrower in width than other regions, on both sides in the widthwise direction. Yet even further, for example, it is characterized in that the number of the third protruding portions is one. Yet even further, for example, it is characterized in that the number of the third protruding portions is two or more. Further, for example, it is characterized that the exterior material is formed of an insulating resin mold member. Yet even further, for example, it is characterized in that the electronic component is a thick film molded divider for high voltage, having the first electrode terminal, the second electrode terminal, and a third electrode terminal provided on the second protruding portion.

### Results of the Invention

According to the present invention, a creepage distance between electrode terminals of an electronic component such as a thick film molded divider can be effectively secured, and mass productivity can be improved.

### BRIEF DESCRIPTION OF DRAWINGS

FIG. 1A is a perspective view of the upper side of a thick film molded divider according to a first embodiment when viewed from a position where a first electrode terminal can be visually recognized:

FIG. 1B is a perspective view of the upper side thereof when viewed from a position where a second electrode terminal and a third electrode terminal can be visually recognized;

FIG. 1C is a perspective view thereof when viewed from the bottom side;

FIG. 2A is a top view of the thick film molded divider illustrated in FIG. 1A when viewed from the upper side in a Z-axis direction;

FIG. 2B is a bottom view thereof when viewed from the lower side in the Z-axis direction;

FIG. 2C is a side view thereof when viewed from a Y-axis direction;

FIG. 2D is an end face view thereof when viewed from a X-axis direction with the first electrode terminal in the foreground;

FIG. 2E is an end face view thereof when viewed from the X-axis direction with the second electrode terminal and the third electrode terminal in the foreground;

FIG. 3 is a cross-sectional view of the thick film molded divider cut in a Y-axis direction along a line indicated by arrows A-A′ of FIG. 1A;

FIG. 4A is a perspective view of a thick film molded divider according to a second embodiment when viewed from the bottom side;

FIG. 4B is a bottom view thereof when viewed from the lower side in the Z-axis direction;

FIG. 4C is a side view thereof when viewed from the Y-direction;

FIG. 5A is a perspective view of a thick film molded divider according to a third embodiment when viewed from the bottom side;

FIG. 5B is a bottom view thereof when viewed from the lower side in the Z-axis direction;

FIG. 5C is a side view thereof when viewed in the Y-direction;

FIGS. 6A to 6D are a perspective view and the like of a thick film molded divider according to Example 1 of a fourth embodiment when viewed from the bottom side;

FIGS. 7A to 7D are a perspective view and the like of a thick film molded divider according to Example 2 of the fourth embodiment when viewed from the bottom side;

FIGS. 8A to 8D are a perspective view and the like of a thick film molded divider according to Example 3 of the fourth embodiment when viewed from the bottom side;

FIGS. 9A to 9D are a perspective view and the like of a thick film molded divider according to Example 4 of the fourth embodiment when viewed from the bottom side;

FIG. 10A is an external perspective view of a thick film molded divider according to Example 1 of a fifth embodiment;

FIG. 10B is a plan view thereof,

FIG. 10C is a side view thereof,

FIGS. 10D and 10E are a right end face view and a left end face view thereof, respectively;

FIG. 11A is an external perspective view of a thick film molded divider according to Example 2 of the fifth embodiment;

FIG. 11B is a plan view thereof,

FIG. 11C is a side view thereof,

FIG. 12A is a perspective view of a thick film molded divider according to Example 1 of a sixth embodiment as viewed from the bottom side;

FIG. 12B is a bottom view thereof,

FIG. 12C is a side view thereof when viewed from the Y-direction;

FIG. 12D is a cross-sectional view thereof cut in the Y-axis direction along a line indicated by arrows E-E′;

FIGS. 13A and 13B are an external perspective view of a thick film molded divider according to Example 2 of the sixth embodiment when viewed from the bottom side;

FIG. 13C is a side view thereof,

FIGS. 13D and 13E are a cross-sectional view thereof cut in the Y-axis direction along a line indicated by arrows F-F′ in FIGS. 13A and 13B;

FIG. 14A is a perspective view of a thick film molded divider according to Example 3 of the sixth embodiment when viewed from the bottom side;

FIG. 14B is a bottom view thereof,

FIG. 14C is a side view thereof when viewed from the Y-direction; and

FIG. 14D is a cross-sectional view thereof cut in the Y-axis direction along a line indicated by arrows K-K′ of FIG. 14A.

### DESCRIPTION OF EMBODIMENTS

Embodiments according to the present invention are described in detail below with reference to accompanying drawings. In the following embodiments, a thick film molded divider is described as a typical example of an electronic component. However, a resistance element to be enclosed in a mold is not limited to a thick film divider. A varistor element. a capacitor element, or other elements can also be used other than the resistance element.

### First Embodiment

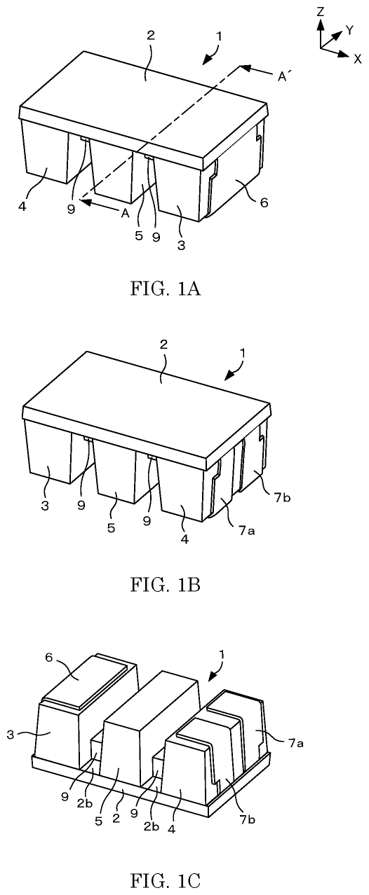

FIGS. 1A to 1C illustrate an external appearance of a thick film molded divider (hereinafter, also simply referred to as “molded divider”) according to a first embodiment of the present invention. FIG. 1A is a perspective view of the upper side (also referred to as “top side”) of a molded divider 1 when viewed from a position where a first electrode terminal 6 that is a lead terminal of the molded divider 1 can be visually recognized. FIG. 1B is a perspective view of the upper side thereof when viewed from a position where a second electrode terminal 7a and a third electrode terminal 7b can be visually recognized. and FIG. 1C is a perspective view of the molded divider 1 when viewed from the bottom side.

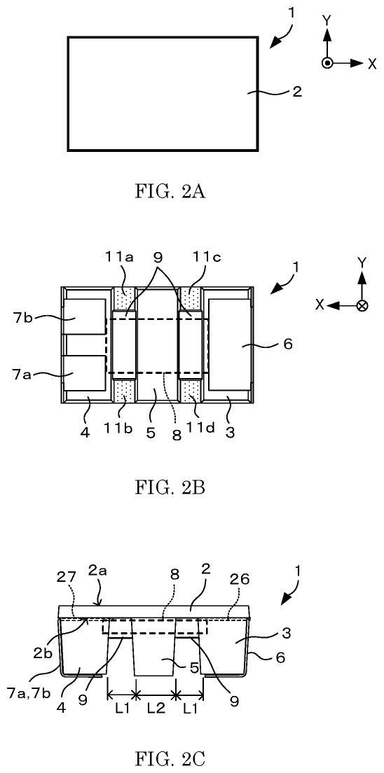

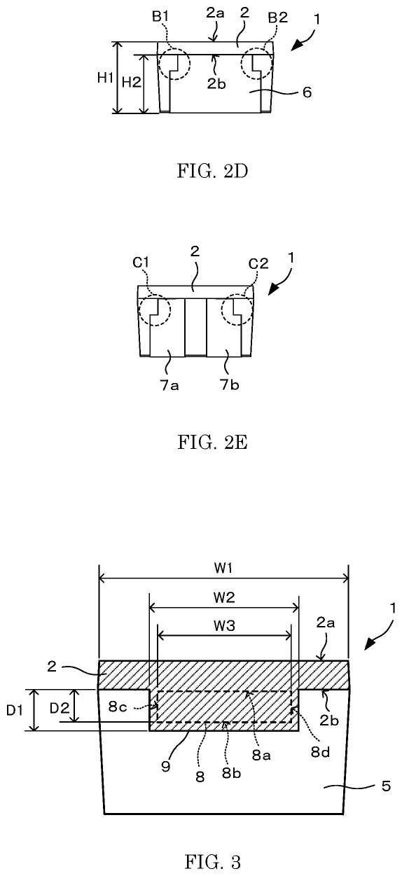

FIG. 2A is a top view of the molded divider 1 illustrated in FIG. 1A when viewed from the upper side in the Z-axis direction. FIG. 2B is a bottom view of the molded divider 1 when viewed from the lower side in the Z-axis direction. FIG. 2C is a side view of the molded divider 1 when viewed from the Y-direction. FIG. 2D is an end face view (also referred to as “right end face view” as appropriate) of the molded divider 1 when viewed from the X-axis direction with the first electrode terminal 6 in the foreground. FIG. 2E is an end face view (also referred to as “left end face view” as appropriate) of the molded divider 1 when viewed from the X-axis direction with the second electrode terminal 7a and the third electrode terminal 7b in the foreground.

Note that a side view of the molded divider 1 when viewed from the opposite side in the Y-direction is the same as the side view in FIG. 2C, and is thus omitted from the drawings.

The molded divider 1 is rectangular in a planar view as illustrated in FIG. 1A etc., and in FIGS. 2A, 2C, etc., and has a structure in which an upper portion 2 having a predetermined thickness in the Z-axis direction is formed, and also a first protruding portion 3, a second protruding portion 4, and a third protruding portion 5 are formed. The first, second, and third protruding portions 3, 4, and 5 extend in a vertical direction (Z-axis direction) from an undersurface side 2b of the upper portion 2, and serve as a leg portion when the molded divider 1 is mounted on a circuit board.

A top surface side 2a of the upper portion 2 is flat so as for a suction nozzle to easily suck and hold the molded divider 1 at the time of mounting the molded divider 1 on the circuit board. The upper portion 2 and the first to third protruding portions 3 to 5 are made of an insulating mold material (mold resin body) that is an exterior member.

On the undersurface side 2b of the upper portion 2. a housing portion 9 is provided, in which a resistance element 8 (for example, a thick film divider, a thin film divider, or a thick film/thin film chip resistor can be used) illustrated by the dashed line in FIGS. 2B, 2C, etc., is housed by sealing with a mold resin. The molded divider 1 with the resistance element 8 inside serves as a voltage-dividing resistor.

The first electrode terminal 6 which is, for example, U-shaped in its entirety in cross section in the X-axis direction, is formed on the first protruding portion 3. The first electrode terminal 6 is a lead frame with its one end 26 connected to one terminal of the resistance element 8 while the other end is folded and arranged to extend in the Z-axis direction along the end surface of the first protruding portion 3 in the X-axis direction, and then to reach the bottom portion of the first protruding portion 3.

On the second protruding portion 4, the second electrode terminal 7a and the third electrode terminal 7b, each of which is, for example, U-shaped in its entirety in cross section in the X-axis direction, are formed in parallel to each other in the Y-axis direction. Each of the second electrode terminal 7a and the third electrode terminal 7b is a lead frame and one end 27 of each of the electrode terminals 7a and 7b is connected to the other terminal of the resistance element 8 while the other end of each of the electrode terminals 7a and 7b is folded and arranged to extend in the Z-axis direction along the end face of the second protruding portion 4 in the X-axis direction, and then to reach the bottom portion of the second protruding portion 4.

The embodiments of the present invention illustrate a thick film molded divider as an example, and thus the divider has three electrode terminals including a ground terminal, a voltage detection terminal, and a high voltage terminal. However, it is allowable that the molded divider has two electrode terminals depending on the type of internal element.

Note that the length of the third protruding portion 5 in the Z-axis direction is set greater than the length of the first protruding portion 3 and the length of the second protruding portion 4 in the Z-axis direction by the thickness of an electrode terminal. That is, the first protruding portion 3 and the second protruding portion 4, each having an end portion of the electrode terminal formed on their bottom portion, have a length in the Z-axis direction that is equal to the length of the third protruding portion 5 in the Z-axis direction, so that it is possible for the molded divider 1 to secure stability at the time of mounting, etc.

Alternatively, the length of the third protruding portion 5 is set slightly greater in the Z-axis direction than the length of the first protruding portion 3 and the length of the second protruding portion 4, and each of which has an end portion of the electrode terminal formed on its bottom portion, so that it is possible for the molded divider 1 to increase the bending strength at the time of mounting, etc.

In the molded divider 1, the third protruding portion 5 is provided at a position spaced apart in the X-axis direction with a predetermined distance from the first protruding portion 3 and the second protruding portion 4. More specifically, as illustrated in FIG. 2C, the first protruding portion 3 and the third protruding portion 5 are spaced apart from each other by L1. and the second protruding portion 4 and the third protruding portion 5 are spaced apart from each other by L1. Let the thickness of the third protruding portion 5 in the X-axis direction be L2, then there is a relationship of L1<L2.

Since the molded divider 1 has the structure as described above, it is possible to secure a creepage distance which is a minimum distance along the surface of the main body of the molded divider 1 between the first electrode terminal 6 and the second and third electrode terminals 7a and 7b that are formed apart from each other in the X-axis direction (longitudinal direction) through the main body of the molded divider 1. Particularly, in order for the molded divider 1, to which a high voltage is applied between the electrode terminals, to exhibit predetermined electrical performance, it is important to secure a sufficient creepage distance between the electrode terminals.

That is, with the molded divider 1, a single third protruding portion 5 is provided between the first protruding portion 3 and the second protruding portion 4, so that it is possible to secure a wider spacing between the protruding portions provided by concave portion that is deep in the vertical direction and also to secure a sufficient creepage distance between the electrode terminals, as compared to the conventional case where a plurality of continuous shallow ribs are provided. As a result, a creepage distance can be secured in consideration of the pollution condition in the environment where the molded divider 1 is installed. For example, the insulation properties under the pollution degree defined in the International Electrotechnical Commission (IEC) 60664-1 can be satisfied.

Furthermore, the third protruding portion 5 has the thickness L2 in the X-axis direction that is set greater than a separation distance L1 from each of the first protruding portion 3 and the second protruding portion 4. Accordingly, the mold formability improves and the mechanical strength of the molded divider 1 in the X-axis direction can be improved, as compared to the conventional example in which a plurality of continuous ribs are provided. As a result, foreign objects or the like are less likely to be trapped between the protruding portions. Even if foreign objects or the like are trapped between the protruding portions, it is still easy to detect the object through inspection, etc. Consequently, mass productivity of the molded dividers improves.

In addition, in the circumstances where molded dividers contact with each other on a parts feeder or in bulk packaging, the third protruding portion 5 of a molded divider can be prevented from being trapped between the first protruding portion 3 and the third protruding portion 5 or between the second protruding portion 4 and the third protruding portion 5 of another molded divider.

Next, the housing portion 9 provided on the undersurface side 2b of the upper portion 2 of the molded divider 1 to seal the resistance element 8 with a mold resin is described. FIG. 3 is a cross-sectional view of the molded divider 1 cut in the Y-axis direction along a line indicated by arrows A-A of FIG. 1A.

As illustrated in FIG. 3, the housing portion 9 provided on the undersurface side 2b of the upper portion 2 of the molded divider 1 has a width W2 in the Y-axis direction that is shorter than a width W1 of the upper portion 2 in the Y-axis direction (widthwise direction). As a result, as illustrated in FIG. 1C. FIG. 3, etc., in the regions from the undersurface side 2b of the upper portion 2 to the housing portion 9, steps equivalent to the thickness (D1 in FIG. 3) of the housing portion 9 in the Z-axis direction are formed on both sides of the molded divider 1 in the widthwise direction.

In the molded divider 1, as illustrated in FIG. 3. when an upper portion 8a of the resistance element 8 sealed in the housing portion 9 with a mold resin is arranged at a position where the upper portion 8a is in contact with the undersurface side 2b of the upper portion 2, the housing portion 9 can have the thickness D1 slightly greater than a thickness D2 of the resistance element 8, and can also have the width W2 slightly greater than a width W3 of the resistance element 8.

With this configuration, the insulating mold member, which covers an undersurface side 8b of the resistance element 8 in the Z-axis direction, and covers both side surfaces 8c and 8d of the resistance element 8 in the X-axis direction in the housing portion 9, can have a thickness as small as possible. This makes it possible around the housing portions 9 to form deeper concave portions between the first protruding portion 3 and the third protruding portion 5 and between the second protruding portion 4 and the third protruding portion 5, and thereby securing a longer creepage distance between the electrode terminals.

With the above-described steps provided along the regions from the undersurface side 2b of the upper portion 2 to the housing portions 9, it is possible for the molded divider 1 to secure a greater mechanical strength, as compared to the conventional structure in which ribs are provided on both lateral sides and the bottom side of the component body and go through these lateral sides and bottom side in the widthwise direction.

The molded divider 1 having the above configuration achieves the effects of improving the mold releasability (formability) as compared to the conventional structure, and preventing foreign objects from being trapped between the protruding portions. In addition, inspection of shape is easily facilitated by using images and the like at the time of shipping so that defective products are less likely to be distributed. Since the amount of mold material to be used is reduced, air entrainment during molding is less likely to occur, and thus formation of a large void inside the protruding portions is prevented. As a result, insulating properties and withstand voltage characteristics of the molded divider may be improved.

Furthermore, the concave portions formed in the vertical direction between the protruding portions 3 and 5 have a structure in which the regions (shaded sections 11a to 11d in FIG. 2B) located on both sides in the widthwise direction of the molded divider 1 are not penetrating the upper portion 2 from the top surface side 2a to the undersurface side 2b (Z-axis direction). With this configuration, it is possible to ensure that the top surface side 2a of the upper portion 2 may have a large area and avoid the mold member in these regions from being reduced in thickness. Therefore, the suction nozzle may easily suck and hold the molded divider 1 at the time of mounting the molded divider 1 on the circuit board by a mounter or the like, and a decrease in strength at these regions may be prevented.

Comparing a region (referred to as “upper region”) of the upper portion 2 in a planar view with a region (referred to as “lower region”) of the first to third protruding portions 3 to 5, etc., in a planar view, excluding the upper portion 2, the molded divider 1 has a structure in which the upper region has a larger area than the lower region.

With this configuration, the first electrode terminal 6, the second electrode terminal 7a, and the third electrode terminal 7b formed on both end surfaces of the molded divider 1 in the longitudinal direction are at positions where these terminals are hidden by the upper region as illustrated in FIG. 1A when the molded divider 1 is viewed in a planar view, and thus do not protrude from both longitudinal end surfaces of the molded divider 1. As a result, it is possible to secure a creepage distance between the electrode terminals via the upper portion 2.

Mold material to be used for the molded divider 1 includes, for example, a liquid crystal polymer (LCP) that is a thermoplastic resin, a polyamide material, and an epoxy resin that is a thermosetting resin.

Note that when considering a tracking resistance of the resin, the thermosetting resin has a higher tracking resistance than that of the thermoplastic resin in general. In view of that, the thermosetting resin is used as a mold material for the molded divider. so that the creepage distance can be set shorter than the case where the thermoplastic resin is used.

Next. the electrode terminals formed in the molded divider 1 are described. The first electrode terminal 6, the second electrode terminal 7a, and the third electrode terminal 7b are made of high conductive material with better solderability, such as copper, etc.

In the regions of the first electrode terminal 6 near the upper portion 2, recessed parts are formed as illustrated by dashed circles B1 and B2 in FIG. 2D. Similarly, as illustrated by dashed circles C1 and C2 in FIG. 1E, recessed parts are also formed in the regions of the second electrode terminal 7a and the third electrode terminal 7b near the upper portion 2.

With the recessed parts formed as described above, along the side surfaces of the molded divider 1 in its longitudinal direction, a longer creepage distance can be secured between the first electrode terminal 6 and the second electrode terminal 7a, and between the first electrode terminal 6 and the third electrode terminal 7b.

The regions indicated by B1, B2, C1, and C2 are equivalent to portions where the electrode terminals (lead frames) are suppressed by mold dies in the manufacturing process of the molded divider, that is, boundary portions between the mold member and the lead frames.

Therefore, by forming the recessed parts in the electrode terminals as described above, the lead frames are configured to have different widths at a part to be covered by the mold and at a part to be solder mounted, so that a region where the frame width dimension can be finely adjusted for the mold dies and a region with a frame width dimension that affects mounting on a circuit board are dimensionally separated. This makes manufacturing of the molded divider easy, and makes it possible to design the mold dies having no effect on the mounting performance.

The first electrode terminal 6 extends in the X-axis direction along the undersurface side 2b of the upper portion 2, on a side connected to the resistance element 8 that is housed in the housing portion 9, and is pulled out to the outside at a location where the first electrode terminal 6 reaches the end surface of the first protruding portion 3 in the X-axis direction.

For example, as illustrated in FIG. 2D, when the height of the position at which the first electrode terminal 6 is pulled out (the height from the bottom side of the molded divider 1 to the undersurface side 2b) is defined as H2, and the height of the molded divider 1 in the Z-axis direction is defined as H1, the first electrode terminal 6 is pulled out to the outside of the first protruding portion 3 from the position at which the relationship of H2>(2/3)H1, more preferably, the relationship of H2>(3/4)H1 is satisfied.

The second electrode terminal 7a and the third electrode terminal 7b are also pulled out to the outside of the second protruding portion 4 from the same pull-out position as the first electrode terminal 6.

By defining the pull-out positions of the electrode terminals as described above, thermal stress may be relieved by the electrode terminals when the molded divider 1 is used under high-voltage, as compared to a configuration, for example, in which the electrode terminals are pulled out from approximately a central part of the protruding portion in the Z-axis direction.

### Second Embodiment

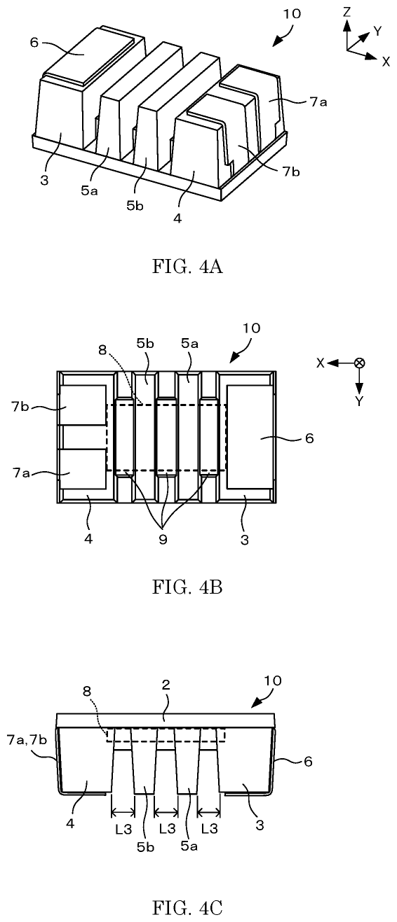

FIGS. 4A to 4C illustrate an external appearance of a thick film molded divider 10 according to a second embodiment of the present invention. FIG. 4A is a perspective view of the molded divider 10 when viewed from the bottom side. FIG. 4B is a bottom view of the molded divider 10 when viewed from the lower side in the Z-axis direction. FIG. 4C is a side view of the molded divider 10 when viewed from the Y-direction.

Note that in the second embodiment and other embodiments, the same components as in the molded divider 1 according to the first embodiment illustrated in FIG. 1, etc., are given the same reference numerals, and description thereof is omitted. A top view, a right end face view, and a left end face view of the molded divider 10 are the same as those in FIGS. 2A, 2D, and 2E, respectively, and are thus omitted from the drawings.

The molded divider 10 according to the second embodiment has a configuration in which two protruding portions (a third protruding portion 5a and a fourth protruding portion 5b) are provided between the first protruding portion 3 and the second protruding portion 4. In this embodiment, as illustrated in FIG. 4C, the first protruding portion 3 and the third protruding portion 5a, the second protruding portion 4 and the fourth protruding portion 5b, and the third protruding portion 5a and the fourth protruding portion 5b are equally spaced apart, respectively, with an interval L3.

Note that in a case where these protruding portions are not evenly spaced apart from each other. L3 is set to 0.5 mm or greater, more preferably, 1 mm or greater in relation to the length of the molded divider 10 in the longitudinal direction (X-axis direction). This makes it possible to secure a desired creepage distance, while maintaining the workability and formability.

As described above, the third protruding portion 5a and the fourth protruding portion 5b are arranged between the first protruding portion 3 on which the first electrode terminal 6 is formed and the second protruding portion 4 on which the second electrode terminal 7a and the third electrode terminal 7b are formed. This makes it possible to secure a longer creepage distance between the electrode terminal 6 and the electrode terminals 7a and 7b.

### Third Embodiment

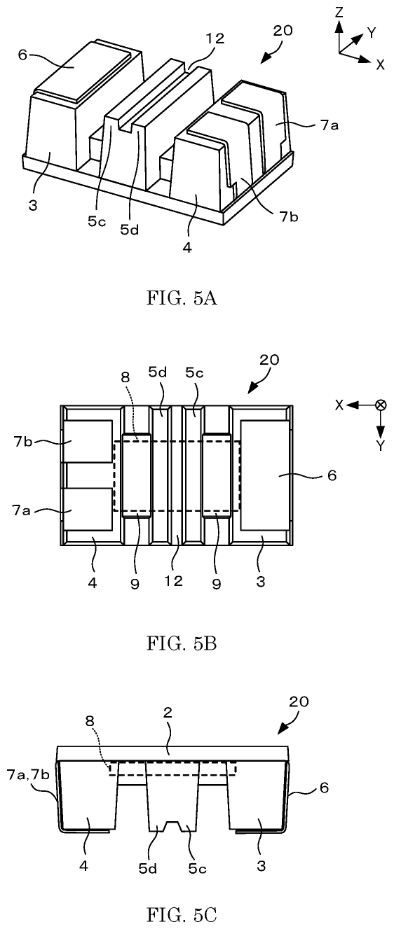

FIGS. 5A to 5C illustrate an external appearance of a thick film molded divider 20 according to a third embodiment of the present invention. FIG. 5A is a perspective view of the molded divider 20 when viewed from the bottom side. FIG. 5B is a bottom view of the molded divider 20 when viewed from the lower side in the Z-axis direction. FIG. 5C is a side view of the molded divider 20 when viewed from the Y-direction.

Note that a top view, a right end face view, and a left end face view of the molded divider 20 are the same as those in FIGS. 2A, 2D, and 2E, respectively, and thus omitted from the drawings.

The molded divider 20 has a configuration in which two protruding portions (a third protruding portion 5c and a fourth protruding portion 5d) are provided between the first protruding portion 3 and the second protruding portion 4. It is characterized in that a concave portion 12 formed between the third protruding portion 5c and the fourth protruding portion 5d is shallower in the Z-axis direction than a concave portion between the third protruding portion 5a and the fourth protruding portion 5b of the molded divider 10 according to the second embodiment.

Accordingly, even with the shallow concave portion 12 formed in the Z-axis direction between the third protruding portion 5c and the fourth protruding portion 5d, it is possible to secure a longer creepage distance between the electrode terminal 6 and the electrode terminals 7a and 7b. In addition, in a case where the third and fourth protruding portions 5c and 5d are fixed to a circuit board using an adhesive when mounting the molded divider 20 on the circuit board, the molded divider 20 may be reliably and firmly fixed to the circuit board by containing an excessive amount of the adhesive in the concave portion 12.

### Fourth Embodiment

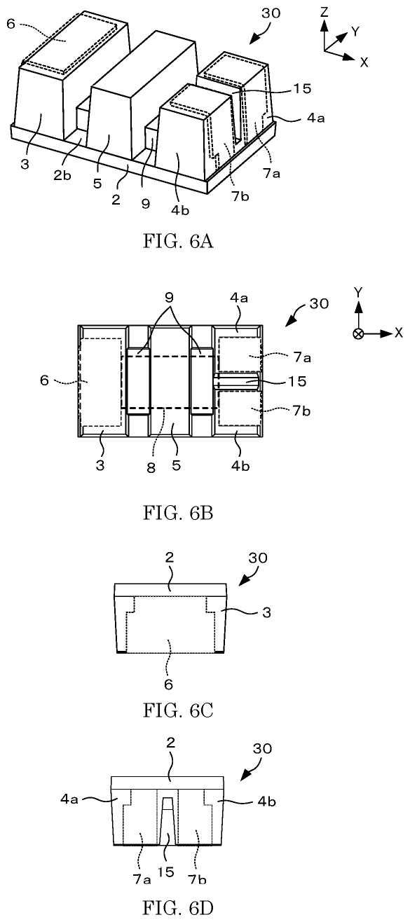

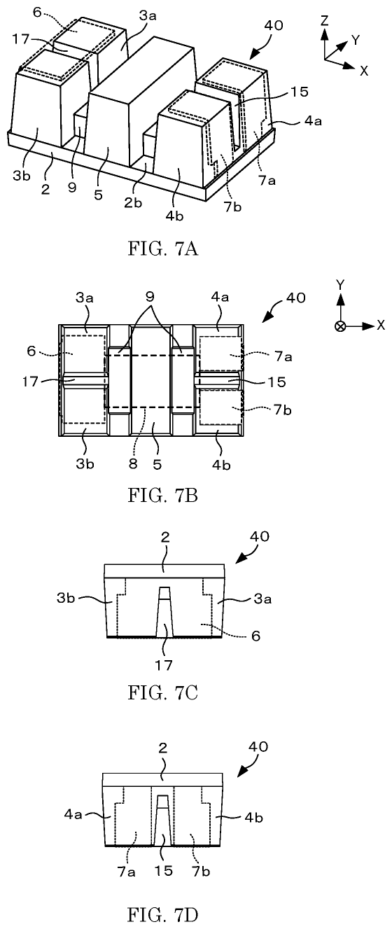

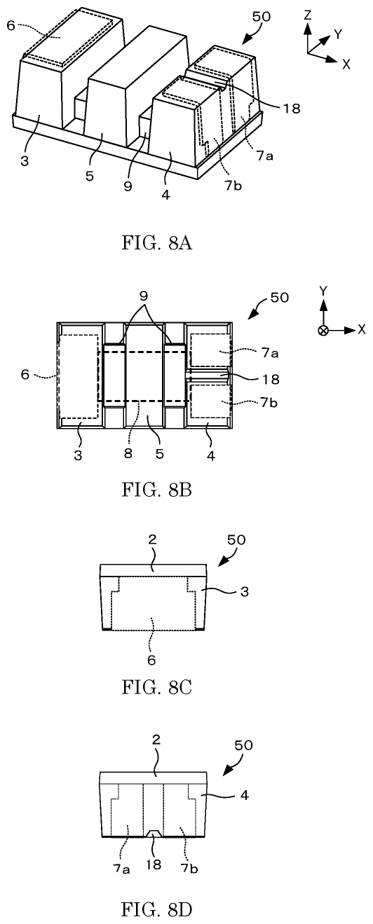

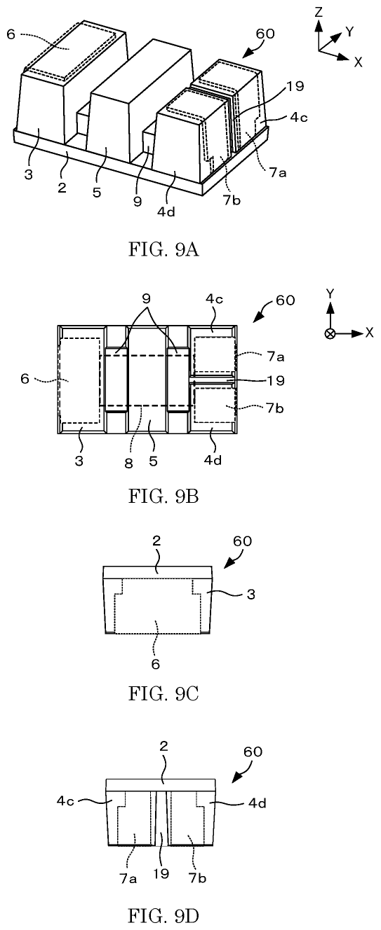

FIGS. 6 to 9 are an external perspective view and the like of a thick film molded divider according to a fourth embodiment of the present invention. FIG. 6A is an external perspective view of a molded divider 30 according to Example 1 of the fourth embodiment when viewed from the bottom side. FIG. 7A is an external perspective view of a molded divider 40 according to Example 2 when viewed from the bottom side. FIG. 8A is an external perspective view of a molded divider 50 according to Example 3 when viewed from the bottom side. FIG. 9A is an external perspective view of a molded divider 60 according to Example 4 when viewed from the bottom side.

FIG. 6A is a perspective view of the molded divider 30 according to Example 1 when viewed from the bottom side. FIG. 6B is a bottom view of the molded divider 30 when viewed from the lower side in the Z-axis direction. FIGS. 6C and 6D are a right end face view and a left end face view of the molded divider 30, respectively. A side view of the molded divider 30 is the same as that in FIG. 2C, and thus omitted from the drawings.

The molded divider 30 according to Example 1 illustrated in FIG. 6A, etc., has a configuration in which the second electrode terminal 7a and the third electrode terminal 7b shown by the dashed lines are arranged on two protruding portions 4a and 4b respectively, which are divided through a concave portion 15 formed along the center line in the X-axis direction.

That is, in Example 1, the concave portion 15 is interposed between the protruding portions 4a and 4b so that the second electrode terminal 7a is formed corresponding to the protruding portion 4a, and the third electrode terminal 7b is formed corresponding to the protruding portion 4b. For example, the concave portion 15 has a depth extending from the undersurface side 2b of the upper portion 2 to the bottom portions of the protruding portions 4a and 4b, while leaving the housing portion 9 as it is. The deeper the depth of the concave portion 15, the better the effects to be described later. However, it is still permissible to set the depth of the concave portion 15 to extend from the undersurface side 2b of the upper portion 2 to a position on the way to the bottom portions of the protruding portions 4a and 4b.

FIG. 7A is a perspective view of the molded divider 40 according to Example 2 when viewed from the bottom side. FIG. 7B is a bottom view of the molded divider 40 when viewed from the lower side in the Z-axis direction. FIGS. 7C and 7D are a right end face view and a left end face view of the molded divider 40, respectively. A side view of the molded divider 40 is the same as that in FIG. 2C, and thus omitted from the drawings.

Similar to Example 1, the molded divider 40 according to Example 2 shown in FIG. 7A. etc., has a configuration in which the second electrode terminal 7a and the third electrode terminal 7b are formed on the two protruding portions 4a and 4b respectively, which are portions divided into two by the concave portion 15. Furthermore, the molded divider 40 has a configuration in which the first electrode terminal 6 is formed on the two protruding portions 3a and 3b which are portions divided into two by a concave portion 17 formed along the center line in the X-axis direction.

In the case of Example 2, the first electrode terminal 6 is formed to across the two protruding portions 3a and 3b as shown by the broken lines in FIG. 7A. etc. For example, the concave portion 17 has a depth extending from the undersurface side 2b of the upper portion 2 to the bottom portions of the protruding portions 3a and 3b, while leaving the housing portion 9 as it is. The deeper the depth of the concave portion 17, the better the effects to be described later. However, it is still permissible to set the depth of the concave portion 17 to extend from the undersurface side 2b of the upper portion 2 to a position on the way to the bottom portions of the protruding portions 3a and 3b.

By dividing the protruding portion into two by the concave portions 15 and 17 respectively, as in Examples 1 and 2, it is possible to secure a space for absorbing thermal contraction and thermal expansion of the mold member which makes up the protruding portions, in a case where the molded divider generates heat when a voltage is applied thereto. With this configuration, the amount of mold material required to form the protruding portions is reduced, air entrainment during molding is less likely to occur, and thus formation of a large void inside the protruding portions is prevented. As a result, insulating properties and withstand voltage characteristics of the molded divider may be improved.

The concave portion 15 formed between the second electrode terminal 7a and the third electrode terminal 7b can prevent an electrical short circuit between these electrode terminals. Furthermore, in the case of Example 2, the protruding portion on which the first electrode terminal 6 is formed, and the protruding portion on which the second electrode terminal 7a and the third electrode terminal 7b are formed, are both separated through the concave portions. Accordingly, the molded divider is balanced in its entirety both in the X-axis direction and the Y-axis direction, thereby maintaining a stabilized mounting condition on the circuit board.

On the other hand, from the viewpoint of preventing a short circuit between the second electrode terminal 7a and the third electrode terminal 7b which are adjacent in parallel. a shallow groove 18 may be formed between these terminals, as with the molded divider 50 according to Example 3 shown in FIG. 8A. etc., in place of the concave portion 15 in the Examples 1 and 2 described above. Alternatively, a narrow groove 19 may be formed which extends from the undersurface side 2b of the upper portion 2 to the bottom portions of the protruding portions, as with the molded divider 60 according to Example 4 shown in FIG. 9A. etc.

Here FIG. 8A is a perspective view of the molded divider 50 according to Example 3 when viewed from the bottom side. FIG. 8B is a bottom view of the molded divider 50 when viewed from the lower side in the Z-axis direction. FIGS. 8C and 8D are a right end face view and a left end face view of the molded divider 50, respectively. A side view of the molded divider 50 is the same as that in FIG. 2C, and thus omitted from the drawings.

FIG. 9A is a perspective view of the molded divider 60 according to Example 4 when viewed from the bottom side. FIG. 9B is a bottom view of the molded divider 60 when viewed from the lower side in the Z-axis direction. FIGS. 9C and 9D are a right end face view and a left end face view of the molded divider 60, respectively. A side view of the molded divider 60 is the same as that in FIG. 2C, and thus omitted from the drawings.

Since a molded divider incorporates the resistance element 8 in the housing portion 9, thermal contraction and thermal expansion of the mold member are repeated when the molded divider generates heat with a voltage applied thereto. In view of this. as described in the fourth embodiment, by forming a concave portion or a groove on the protruding portion at one end of the molded divider or on the protruding portions at both ends of the molded divider in the longitudinal direction as shown in FIGS. 6 to 9, a larger space for absorbing thermal expansion can be secured in addition to the space between the protruding portions, than the case where a concave portion or a groove is not formed.

### Fifth Embodiment

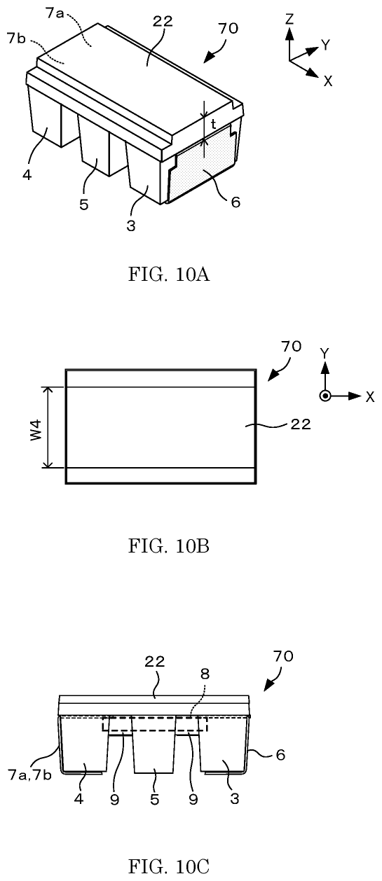

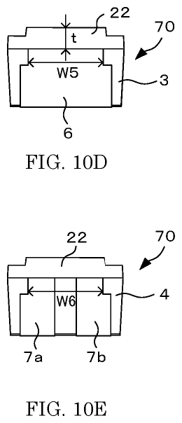

FIG. 10A is an external perspective view of a thick film molded divider 70 according to Example 1 of a fifth embodiment of the present invention. FIG. 10B is a plan view of the molded divider 70. FIG. 10C is a side view thereof. FIG. 10D is a right end face view of the molded divider 70 when viewed from the X-axis direction with the first electrode terminal 6 in the foreground, and FIG. 10E is a left end face view thereof with the second and third electrode terminals 7a and 7b in the foreground.

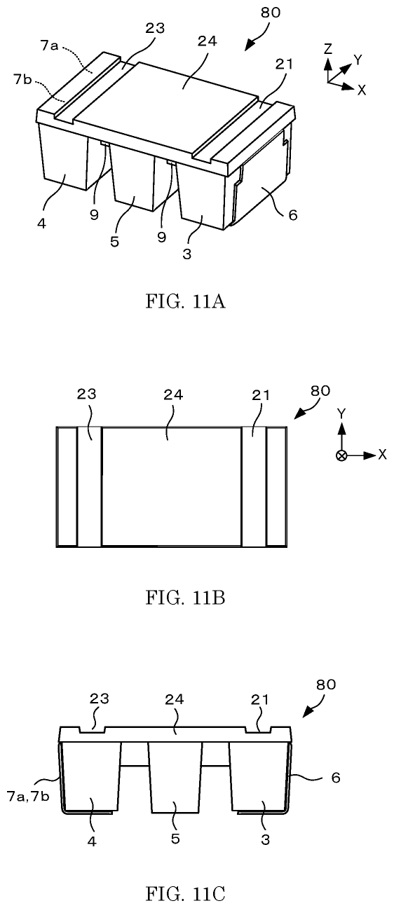

FIG. 11A is an external perspective view of a thick film molded divider 80 according to Example 2 of the fifth embodiment of the present invention. FIG. 11B is a plan view thereof, and FIG. 11C is a side view thereof. A right end face view and a left end face view of the molded divider 80 are the same as those in FIGS. 2D and 2E, respectively, and thus omitted from the drawings.

There is a possibility that the thermal contraction and thermal expansion of the mold member are repeated in the molded dividers as described above, and the component in its entirety may be deformed into an arcuate shape around the central part of the upper portion. Therefore, the molded divider 70 according to Example 1 illustrated in FIGS. 10A to 10E has an upper portion 22 with a thickness t in the Z-axis direction greater than the thickness of the upper portion according to the other embodiments described above. This makes it possible to reinforce the upper portion of the molded divider and at the same time, to secure a longer creepage distance between the electrode terminal 6 and the electrode terminals 7a and 7b. In this case, it is preferable that in the Y-axis direction, a width W4 of a thicker portion having a thickness t is set larger than a width W5 of a portion where the electrode terminal 6 is pulled out and is also set larger than a width W6 of a portion where the electrode terminals 7a and 7b are pulled out.

The molded divider 80 according to Example 2 illustrated in FIGS. 11A to 11C, has a configuration in which shallow concave portions 21 and 23 extending in the Y-axis direction (widthwise direction) are formed near both ends of the top side of an upper portion 24 in the X-axis direction.

With this configuration, in addition to the space formed between the first protruding portion 3 and the third protruding portion 5, and the space formed between the second protruding portion 4 and the third protruding portion 5, spaces made by the concave portions 21 and 23 which are formed on the upper portion 24, serve as a space for absorbing thermal expansion of the molded divider 80. As a result, with respect to direction of deformation caused by thermal contraction and thermal expansion, the upper portion 24 of the mold and the lower portion of the mold differ by 90 degrees, where the lower portion includes the housing portions 9, the first protruding portion 3, the second protruding portion 4, and the third protruding portion 5. It is thus possible to prevent the entire molded divider 80 from becoming deformed into an arcuate shape due to heat generation.

Furthermore, the concave portions 21 and 23 are formed on the upper portion 24, so that, on the upper surface of the molded divider 80, it is possible to secure a longer creepage distance between the electrode terminal 6 and the electrode terminals 7a and 7b.

### Sixth Embodiment

In order for a thick film molded divider to secure a creepage distance between electrode terminals, it is necessary to form irregularities (unevenness) on the outer sides of a molded body. However, if there is a difference in thickness in different parts of the mold member, mechanical strength becomes an issue.

Taking the above-described molded divider illustrated in FIG. 2B as an example, the mold member becomes thinner at the concave portions between the protruding portions 3 to 5 (particularly, at the shaded sections 11a to 11d). It is thus assumed that these sections are less strong. Therefore, it is important to have a structure for balancing securing the creepage distance and having a component strength.

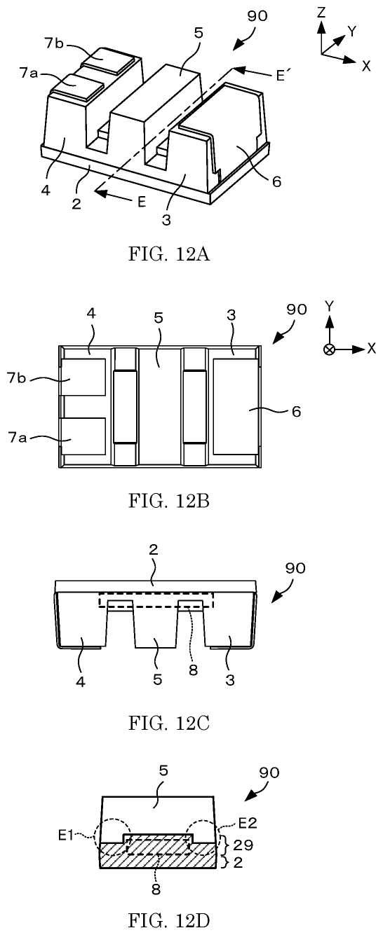

FIG. 12A is a perspective view of a molded divider 90 according to Example 1 of the thick film molded divider of a sixth embodiment, illustrating an external appearance of the molded divider 90 when viewed from the bottom side and FIG. 12B is a bottom view thereof. FIG. 12C is a side view of the molded divider 90 when viewed from the Y-axis direction, and FIG. 12D is a cross-sectional view cut in the Y-axis direction along a line indicated by arrows E-E′ of FIG. 12A.

Note that a top view, a right end face view, and a left end face view of the molded divider 90 are the same as those in FIGS. 2A, 2D, and 2E, respectively, and are thus omitted from the drawings.

The molded divider 90 according to Example 1 has a configuration in which, in a concave portion between the first protruding portion 3 and the third protruding portion 5, and in a concave portion between the second protruding portion 4 and the third protruding portion 5 as illustrated in FIG. 12D, both end parts in the Y-axis direction of a housing portion 29 which houses the resistance element 8 are formed in a staircase shape (illustrated by dashed circles E1 and E2 in the drawing).

This enables the molded divider 90 according to Example 1 to balance securing the creepage distance and having a sufficient component strength.

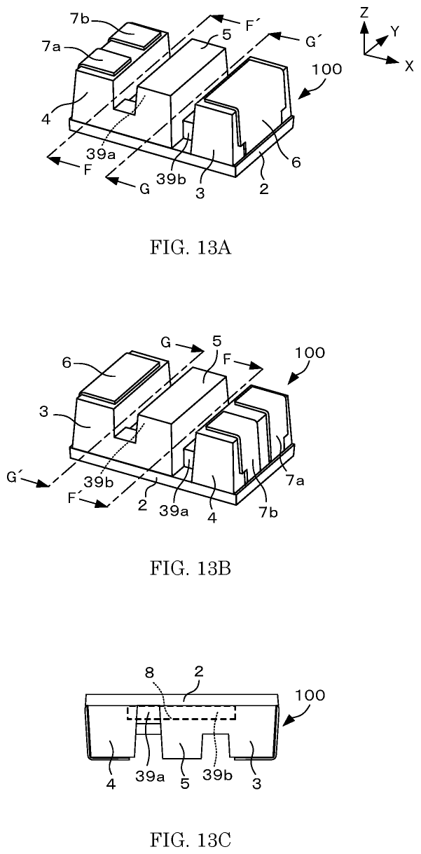

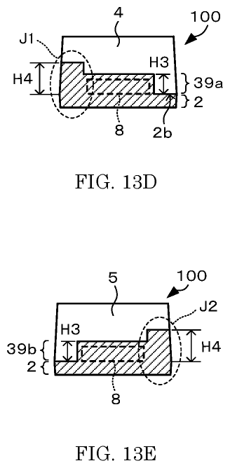

FIGS. 13A and 13B are a perspective view of a molded divider 100 according to Example 2 of the thick film molded divider of the sixth embodiment when viewed from the bottom side. FIG. 13A illustrates an external appearance thereof when viewed from a position where the first electrode terminal 6 can be visually recognized in its entirety, and FIG. 13B illustrates an external appearance thereof when viewed from a position where the second electrode terminal 7a and the third electrode terminal 7b can be visually recognized.

FIG. 13C is a side view of the molded divider 100 when viewed from the Y-axis direction. FIG. 13D is a cross-sectional view of the molded divider cut in the Y-axis direction along a line indicated by arrows F-F of FIGS. 13A and 13B. FIG. 13E is a cross-sectional view of the molded divider cut in the Y-axis direction along a line indicated by arrows G-G′ of FIGS. 13A and 13B.

Note that a top view, a bottom view, a right end face view, and a left end face view of the molded divider 100 are the same as those in FIGS. 2A. 2B. 2D. and 2E. respectively, and are thus omitted from the drawings.

The molded divider 100 according to Example 2 has a configuration in which, in a concave portion between the second protruding portion 4 and the third protruding portion 5, a first wall-shaped portion (illustrated by a dotted ellipse J1) is formed at one end part in the Y-axis direction of a housing portion 39a which houses the resistance element 8, as illustrated in FIG. 13D. In a concave portion between the first protruding portion 3 and the third protruding portion 5, a second wall-shaped portion (illustrated by a dotted ellipse J2) is formed at the other end part in the Y-axis direction of a housing portion 39b which houses the resistance element 8, as illustrated in FIG. 13E.

That is, when the molded divider 100 is viewed in a planar view, the first wall-shaped portion and the second wall-shaped portion are arranged at opposite end parts of the concave portions which are in parallel in the Y-axis direction between the protruding portions (arranged at diagonally facing positions).

As illustrated in FIGS. 13D and 13E, the molded divider 100 has a configuration in which the first wall-shaped portion and the second wall-shaped portion are formed to have a height H4 in the Y-axis direction that is greater than a height H3 in the Y-axis direction of the housing portions 39a and 39b. However, when the first wall-shaped portion and the second wall-shaped portion are formed higher, it is difficult to secure a creepage distance. Therefore, the molded divider 100 has a wall-shaped portion at one place on one side surface thereof, and has a wall-shaped portion at one place on the other side surface thereof.

With the first wall-shaped portion and the second wall-shaped portion arranged in a manner described above, it is possible for the molded divider 100 to balance securing the creepage distance and having a sufficient component strength.

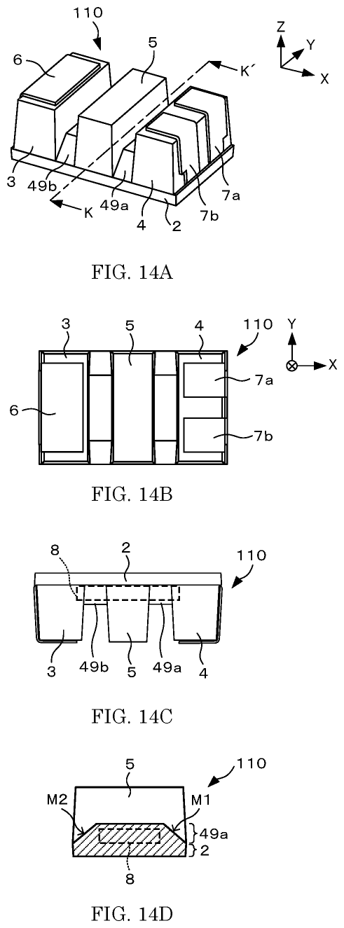

FIG. 14A is a perspective view of a molded divider 110 according to Example 3 of the thick film molded divider of the sixth embodiment, illustrating an external appearance of the molded divider 110 when viewed from the bottom side, and FIG. 14B is a bottom view thereof. FIG. 14C is a side view of the molded divider 110 when viewed from the Y-direction, and FIG. 14D is a cross-sectional view of the molded divider 110 cut in the Y-axis direction along a line indicated by arrows K-K′ of FIG. 14A.

Note that a top view, a right end face view, and a left end face view of the molded divider 110 are the same as those in FIGS. 2A, 2D, and 2E, respectively, and are thus omitted from the drawings.

As illustrated in FIGS. 14A and 14C, the molded divider 110 according to Example 3 has a configuration in which, in a concave portion between the first protruding portion 3 and the third protruding portion 5, and in a concave portion between the second protruding portion 4 and the third protruding portion 5, inclined portions M1 and M2 are formed at both end parts in the Y-axis direction of housing portions 49a and 49b which houses the resistance element 8.

The molded divider 110 having these inclined portions M1 and M2 may also balance securing the creepage distance and having a sufficient component strength.

Respective embodiments explained above are described to facilitate the understanding of the present invention and are not described to limit the present invention, and may be appropriately changed within the scope in which the effect of the present invention can be exerted. Further, respective constituent elements of the present invention may be arbitrarily selected and inventions comprising such selected constituents are also included in the present invention.

### DESCRIPTION OF REFERENCE NUMERALS

1, 10, 20, 30, 40, 50, 60, 70, 80, 90, 100, 110: Thick film molded driver
2, 22, 24: Upper portion
2a: Top surface side of upper portion
2b: Undersurface side of upper portion
3: First protruding portion
4: Second protruding portion
5, 5c: Third protruding portion
5d: Fourth protruding portion
6: First electrode terminal
7a: Second electrode terminal
7b: Third electrode terminal
8: Resistance element
9, 29, 39a, 39b, 49a, 49b: Housing portion
12, 15, 17, 21, 23: Concave portion
18, 19: Groove
M1, M2: Inclined portion

1. An electronic component comprising:
an upper portion made of a plate-like exterior material and having a rectangular shape in a planar view;
a housing portion arranged substantially at a center part on an undersurface side of the upper portion and made of an exterior material for embedding a resistance element therein;
a first protruding portion made of an exterior material, formed upright at one end side in a longitudinal direction of an undersurface side of the upper portion, having a predetermined height in a vertical direction from the undersurface side, and having a first electrode terminal provided thereon;
a second protruding portion made of an exterior material, formed upright at the other end side in a longitudinal direction of an undersurface side of the upper portion, having a predetermined height in a vertical direction from the undersurface side, and having a second electrode terminal provided thereon; and
a third protruding portion made of an exterior material, formed upright on an undersurface side of the upper portion and at a position where the third protruding portion is sandwiched between the first protruding portion and the second protruding portion, while being spaced apart with a predetermined distance from each of the first protruding portion and the second protruding portion, and having a predetermined height in a vertical direction from the undersurface side, wherein
each of the first protruding portion, the second protruding portion, and the third protruding portion is formed to extend from one end part to the other end part in a widthwise direction of the undersurface side, while having a constant width in the longitudinal direction.

2. The electronic component according to claim 1, wherein the third protruding portion has a width in the longitudinal direction greater than a separation distance between the first protruding portion and the third protruding portion, and a separation distance between the second protruding portion and the third protruding portion.

3. The electronic component according to claim 1, wherein the third protruding portion has a height in the vertical direction greater than a height of the first protruding portion in the vertical direction and a height of the second protruding portion in the vertical direction.

4. The electronic component according to claim 1, wherein between the first protruding portion and the third protruding portion, and between the second protruding portion and the third protruding portion, regions on both end face sides in the widthwise direction of the undersurface side and the regions adjacent to the housing portion have a depth in the vertical direction greater than a depth of the housing portion in the vertical direction.

5. The electronic component according to claim 4, wherein the regions remain as they are without penetrating the upper portion in the vertical direction from a top surface side to an undersurface side.

6. The electronic component according to claim 1, wherein the upper portion has an area where the first electrode terminal and the second electrode terminal are hidden by the upper portion in a planar view.

7. The electronic component according to claim 1, wherein each of the first electrode terminal and the second electrode terminal is pulled out to the outside through the exterior material from a position three-quarters or more of the height of the first protruding portion and the second protruding portion in the vertical direction.

8. The electronic component according to claim 7, wherein, at the position where the electrode terminal is pulled out the outside, each of the first electrode terminal and the second electrode terminal has predetermined regions narrower in width than other regions, on both sides in the widthwise direction.

9. The electronic component according to claim 1, wherein the number of the third protruding portions is one.

10. The electronic component according to claim 1, wherein the number of the third protruding portions is two or more.

11. The electronic component according to claim 1, wherein the exterior material is made of an insulating resin mold member.

12. The electronic component according to claim 1, wherein the electronic component is a thick film molded divider for high voltage, having the first electrode terminal, the second electrode terminal, and a third electrode terminal provided on the second protruding portion.

13. The electronic component according to claim 2, wherein between the first protruding portion and the third protruding portion, and between the second protruding portion and the third protruding portion, regions on both end face sides in the widthwise direction of the undersurface side and the regions adjacent to the housing portion have a depth in the vertical direction greater than a depth of the housing portion in the vertical direction.

14. The electronic component according to claim 3, wherein between the first protruding portion and the third protruding portion, and between the second protruding portion and the third protruding portion, regions on both end face sides in the widthwise direction of the undersurface side and the regions adjacent to the housing portion have a depth in the vertical direction greater than a depth of the housing portion in the vertical direction.

15. The electronic component according to claim 2, wherein the number of the third protruding portions is one.

16. The electronic component according to claim 3, wherein the number of the third protruding portions is one.

17. The electronic component according to claim 2, wherein the number of the third protruding portions is two or more.

18. The electronic component according to claim 3, wherein the number of the third protruding portions is two or more.
